(19) United States
(12) Patent Application Publication
(10) Pub. No.: US 2004/0205764 A1
(43) Pub. Date: Oct. 14, 2004

(54) System and method for providing information regarding server traffic

(76) Inventors: Joseph J. Snyder, Shamon, NJ (US); Jason Kinner, Marlton, NJ (US); Richard Friedman, Cherry Hill, NJ (US)

Correspondence Address: HEWLETT-PACKARD DEVELOPMENT COMPANY, Intellectual Property Administration, P.O. Box 272400, Fort Collins, CO, 80527-2400, US

(21) Appl. No.: 10/371,734

(22) Filed: Feb. 21, 2003

(51) Int. Cl. G06F 3/00; G06F 15/16; G06F 13/00; G06F 7/00

(52) U.S. Cl. 719/311; 707/10; 709/203

(57) ABSTRACT

A server system for providing information regarding server traffic, comprising a servlet residing within a servlet container configured to receive a request, process the request, and formulate a response corresponding to the request, and logic contained within the servlet container configured to receive the request and index the request, the logic configured to receive the requests from the servlet container.

### BACKGROUND

Typically, an internet user employs a web browser in order to communicate with a web server. In using the web browser, the user enters an Universal Resource Locator (URL). Thereafter, the user's computer, sometimes referred to as “the client,” assembles requests to be communicated to the web server, and the web browser transmits such requests to the web server using the URL entered by the user. A well-accepted request and response formatting standard in the art is Hypertext Transfer Protocol (HTTP).

Upon receipt of a request from the web browser, the web server processes the request and then transmits a response back to the client. Note that the content of the request corresponds to the type of information that the client is searching for and thereby defines the steps to be taken by the web server when responding to the request. For example, if the user enters a specific URL, which requests just an image or a Hypertext Markup Language (HTML) file, the web server locates the image or file and transmits the image or file back to the client.

In addition to locating an image or a file and transmitting it back to the client, many requests from clients may instruct the web server to take some other action. For example, a request may instruct the web server to perform a search on a database, and the search results may then be displayed by the web browser associated with the client. Traditionally, a web server employs a Common Gateway Interface (CGI), which implements scripts written in software languages, for example Perl or C programs. However, with the advent of Java, small programs that run on the web server, referred to in the art as “servlets,” process client requests that require additional tasks and return results to the client.

A servlet is generally a standardized function that receives and processes client requests, thereby generating responses to the client requests. Typically, servlets are written in Java™ in accordance with a standard promulgated by the Java Community Process (JCP), and are designed to run on a web server. The foregoing servlet standard simply defines a uniform foundation on which to design and write servlets. Generally, the servlet function is primarily to generate a response to a client request. For web servers that have not been designed to run servlets, there exist servlet engines that may be downloaded to serve as a plug-in for enabling such servers to run servlets. Thus, almost all web servers can run servlets, or can be modified to run servlets, in order to facilitate web client/server communication.

Typically, a servlet resides within a servlet container, which and serves as an interface for all servlets encapsulated by it. A servlet container, for example an Apache Tomcat, is typically a program that monitors a port of an internet protocol address (IP address). In monitoring the port, the servlet container receives a request for the servlet, which is sent by the client. Before passing the request to the servlet, the servlet container parses the request, and puts the parsed information in a format that is compatible with the servlet. The servlet container also receives a response created by the servlet and formats the response for transmission back to the client.

The uniform characteristics of the servlet container standard and the servlet standard provide a predictable environment in which to write servlet-based applications. More specifically, there exists in the industry numerous web servers, which are designed very differently. However, most web servers today employ the Java™-based servlet container and servlet standards. Therefore, regardless of the type of web server used, the servlet container interface and its interaction with the servlet provide an environment that allows applications that can be used with most web servers.

Moreover, there also exists, in the industry, open source, search/index engines such as the Lucene application program interface (API). An API is generally a compilation of tools, which a programmer a can use to create an application that can be used across a wide-range of platforms and web servers. Therefore, the Lucene API provides a programmer with tools for building a data repository by indexing the data and tools for searching the repository. As such, a programmer can create an application that is data specific. For example, the programmer can create a repository of products, including product descriptions and prices, and the programmer can then create an application for providing efficient searching of the product repository, for example when a web user is viewing an online catalog.

Note that indexing is a term of art related to data repository design and generally refers to providing a list of keys, which are used to sort data, each of which identifies a unique record. A record refers to a collection of data that is to be stored within a repository. The indices allow an application to find data stored in the repository in a more efficient manner.

### SUMMARY

Generally, embodiments of the present invention provide a system for providing information regarding server traffic comprising a servlet residing within a servlet container configured to receive a request, process the request, and formulate a response corresponding to the request, and logic contained within the servlet container configured to receive the request and index the request, the logic configured to receive the requests from the servlet container.

An embodiment of the present invention can further be conceptualized as a method comprising the steps of receiving a request within a servlet container of the web server, the request transmitted from a client to the web server, indexing the request, storing the request in a repository, formulating a response to the request, and transmitting the response to the client.

### BRIEF DESCRIPTION OF THE DRAWINGS

The embodiments of the invention can be better understood with reference to the following drawings.

FIG. 1 is a block diagram illustrating a client/server system according to a representative embodiment of the present invention.

FIG. 2 is a block diagram illustrating an exemplary embodiment of a server system of FIG. 1.

FIG. 3 is a block diagram illustrating a more detailed embodiment of the server system of FIG. 2.

FIG. 4 is a flowchart illustrating an exemplary architecture and functionality of a server system depicted in FIG. 2.

### DETAILED DESCRIPTION

In general, embodiments of the present invention pertain to a web-based server system that provides a data repository of client requests and server responses for automated or manual interactions. A web-based server system in accordance with an exemplary embodiment of the present invention comprises a search request filter and a search response filter that are web-server and servlet container non-discriminatory. In this regard, the search request filter and search response filter may be utilized by various types of web servers (i.e., Microsoft web servers, IBM web servers, customized web servers, etc.).

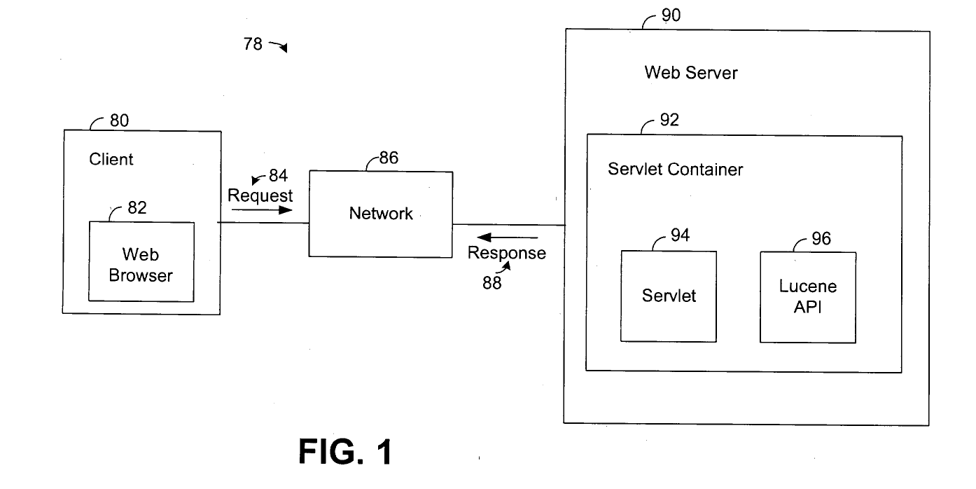

FIG. 1 illustrates a client/server system 78 that employs a servlet-based architecture to facilitate internet communication. As indicated in FIG. 1, the client 80 comprises a known or future-developed web browser 82, such as, for example, Netscape or Internet Explorer. A user (not shown) enters a URL in the web 82 via an input device (not shown), or an automated mechanism specifies a specific URL, for example in a hypertext link contained within a HTML file. The client 80 transmits, to a web server 90, a request 84 that includes the specified URL.

The web server 90 typically comprises a servlet container 92, which encompasses a servlet 94. As described hereinabove, a servlet refers to a program that receives client requests, processes the requests, and transmits responses corresponding to the requests back to the requesting client. The web server 90 of FIG. 1 further comprises the Lucene API 96, which resides within the servlet container 92 and can be used to create data repositories, which are searchable via requests through the servlet 94.

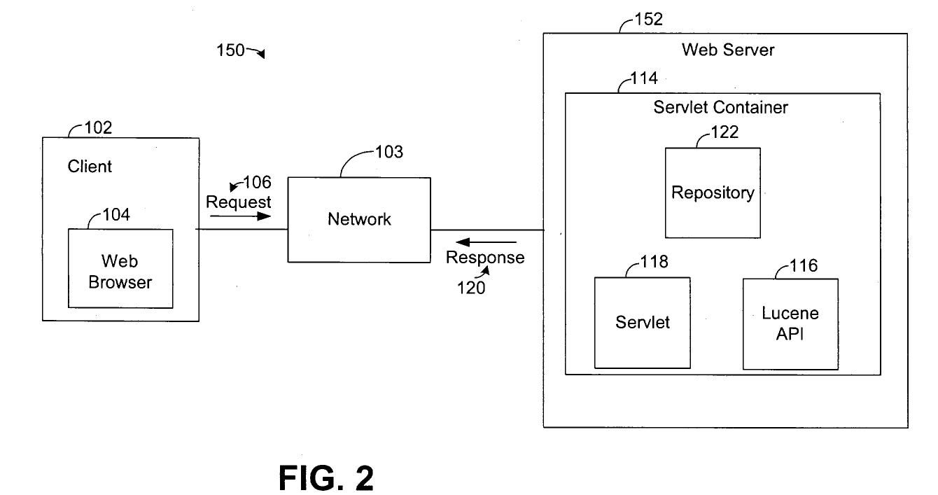

A web-based server system in accordance with an exemplary embodiment of the present invention is illustrated in FIG. 2, and is generally referred to throughout as client server system 150. The system 150 of FIG. 2 comprises a client 102 and a web server 152, which communicate through network 103. The client 102 comprises a web browser 104, and the web server 152 comprises a servlet container 114, which encompasses a Lucene API 116, a servlet 118, and a request/response repository 122.

The Lucene API 116 of FIG. 2 provides a mechanism by which a set of data, for example product data associated with an online catalog, can be converted into a searchable form and stored in a repository 122. The repository 122 may comprise a structured database, or in the case of the Lucene API 116, the repository 122 may be a directory containing files indicative of the stored data.

Once the data is stored, the data may be searched and retrieved, from the repository 122, by the client 102. In this regard, a search and retrieval may be initiated by a user (not shown), via a search form displayed by the web browser 104, or a search and retrieval may be automatically performed by another search engine or by a request from a hyperlink contained within a web page. Note that a data repository 122 can take various forms. For example, a repository may be a structured database, or it could be a file structure stored on a server.

In the exemplary embodiment of FIG. 2, the client 102 assembles a request and transmits the request 106 via network 103 to the web server 152. The client 102 may assemble the request based upon a URL entered into the web browser 104, or the client 102 may assemble the request based upon an automated process, for example, a hyperlink within an HTML document selected by a user may also cause the client 102 to assemble a request and transmit the request to the web server 152.

The web server 152 receives the request from the client 102 and transmits the request to the servlet container 114. The servlet container 114 parses the request, puts the request in a format compatible with the servlet 118, then the servlet container 114 transmits the request to the servlet 118. The servlet 118 processes the request and transmits a response to the servlet container 114. The servlet container 114 transmits the request to the web server 152, which transmits the response 120 to the client 102.

During the process of receiving the request, processing the request, and transmitting a response back to the client, the web server 152 is configured to generate a repository 122 that comprises a searchable compilation of data indicative of requests that are received by the servlet 118 and indicative of responses formulated by the servlet 118. Note that the data indicative of the requests and responses may take varying forms. In this regard, the compilation of data may include records comprising all the data contained within the request or the response, or the compilation of data may include records that contain only a selected portion of the response (i.e., a record in the repository may only include a select number of fields from the response with their corresponding values). The web server 152 may be configured to create a compilation of all the requests and responses that are processed on the web server 152, or it may be configured to compile a repository 122 of only a particular type of request or response. For example, an HTTP request may comprise a GET command or a PUT command, and the web server 152 may only be configured to compile a repository 122 of the data indicative of the requests that include a GET command. In other embodiments, the web server 152 may be configured to compile a repository 122 of the data indicative of the requests that originate from a particular source or IP address.

The data compiled by the web server 152 in the repository 122 may then be searched and presented by the client 102. Note that the presentation could be in any known format (i.e., HTML or extensible markup language (XML)). Thus both human and machine interaction is preferably provided. Such access and search capabilities provide a user with the ability to discover information pertaining to the web server traffic, such as, for example, information indicative of web server performance or other information of user interest. The search and presentation is preferably provided through a search/index mechanism, for example, the Lucene API 116. As an example, client requests may include information or data that identifies a particular HTML file requested by a user, which the repository 122 may be configured to retain. The user could then use the information related to a specific HTML file requested to determine the amount of traffic with respect to a single HTML file.

In order to access the data contained within the repository 122, the web server 152 may transmit a search page to the client 102, which is displayed in the web browser 104. The search page preferably includes at least a text field for entering a search string related to the type of data that a user may be interested in accessing in the repository. When a user enters a search string, the client 102 preferably compiles a request and transmits the request to the web server 152. The search string may then be used by the servlet 118 to retrieve from the repository 122, those records that match the string entered by the user and formulate the response that the web server 152 transmits to the client 102. For example, a system administrator may be interested in determining the number of times that a particular HTML file defining a particular page is requested from the web server 152. To discover this information, the system administrator may enter the name of the HTML file in a search page displayed in web browser 104. The web server 152 then searches the repository 122 and transmits the results back to the client 102.

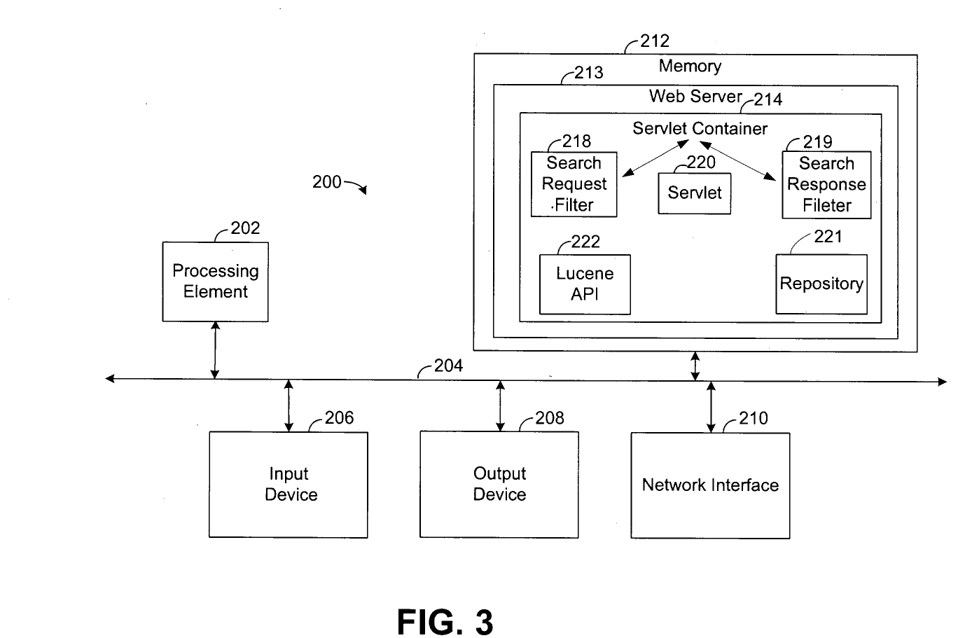

FIG. 3 depicts an exemplary embodiment of a computer system 200 that may be used to implement the web server 213, and the servlet container 214 residing therein. As shown by FIG. 3, the system 200 comprises a search request filter 218 and a search response filter 219, and is generally referred to throughout as “web server system 200.” Note that the search request filter 218, the search response filter 219, the servlet 220 and the Lucene filter 222 are preferably implemented in software and stored in memory 212, as shown by FIG. 3. However, the foregoing components may be implemented in hardware, software, or a combination thereof.

Note that when implemented in software, the components of the web server 213 can be stored and transported on any computer-readable medium for use by or in connection with an instruction execution system, apparatus, or device, such as a computer-based system, processor-containing system, or other system that can fetch the instructions from the instruction execution system, apparatus, or device and execute the instructions. In the context of this document, a “computer-readable medium” can be any means that can contain, store, communicate, propagate, or transport the program for use by or in connection with the instruction execution system, apparatus, or device. The computer-readable medium can be, for example but not limited to, an electronic, magnetic, optical, electromagnetic, infrared, or semiconductor system, apparatus, device, or propagation medium. Note that the computer-readable medium could even be paper or another suitable medium upon which the program is printed, as the program can be electronically captured, via for instance optical scanning of the paper or other medium, then compiled, interpreted or otherwise processed in a suitable manner if necessary, and then stored in a computer memory. As an example, the components of the web server 213 may be magnetically stored and transported on a conventional portable computer diskette.

The exemplary embodiment of the web server system 200 of FIG. 2 comprises at least one processing element 202, such as a digital signal processor (DSP) or a central processing unit (CPU), for example, that communicates to and drives the other elements within the system 200 via a local interface 204, which can include one or more buses. The system 200 may also include an input device 206, for example, a keyboard or a mouse, that can be used to input data from a user of the system 200, and an output device 208, for example, a screen display or a printer, can be used to output data to the user. The system 200 is preferably connected to a network interface 210 that allows the system 200 to exchange data with a client 102 over a network 103 (FIG. 2), such as the Internet, for example.

The computer system 200 is configured to communicate over network 103 (FIG. 2) via the network interface 210 with a client 102 (FIG. 2). A user of the client 102 may enter, or otherwise provide, a URL, which is received by the web browser 104 (FIG. 2), which is installed on the client 102. Note that the web browser can comprise various types of known or future-developed web browsers, including Netscape or Explorer. Further note that the platform on which the client is implemented may include a Macintosh operating system, a Windows operating system, a UNIX system, a LINUX system, or other type of operating system. When the user enters a URL, the client 102 typically assembles a request and transmits the request via network 103 to the system 200 through the network interface 210. The network interface 210 may comprise a dial-up connection, an integrated services digital network line (ISDN line), a digital subscriber Line (DSL) or any other type of network interface known in the art or future-developed.

The web server 213 receives the request and transmits the request, preferably in accordance with the servlet standard defined by JCP, to the servlet container 214. The servlet container 214 then parses the request to determine what type of instruction request has been received. As indicated herein, requests preferably comprise predictable data, which may include commands, for example GET and PUT, an IP address of the client, or other data otherwise describing the request. Typically, this type of data is contained within a header, which makes up part of the request sent by the client 102. As such, the servlet container 214 is preferably configured to retain configuration data that associates a search filter with a particular piece of data. For example, the servlet container 214 may comprise configuration data that indicates that all requests that contain GET commands are sent to the search request filter 218. Therefore, when the servlet container 214 receives, from the web browser 213, a request that contains a GET command, the servlet container 214 transmits the request to the search request filter 218.

In this regard, the servlet container 214 preferably compares selected pieces of parsed data with the configuration data to determine if a piece of data is associated with the search request filter 218. If the servlet container 214 determines that the data is associated with the search request filter 218, then the servlet container 214 transmits the request to the search request filter 218.

Upon receiving the request from the servlet container 214, the search request filter 218 may convert the data into a format that is compatible with the type of API that is being used, for example if using the Lucene API, then the search request filter 218 preferably converts the data into document having a plurality of fields. Further, associated with each field is a value. For example, the search request filter 218 may convert the request data into a document that has two fields, a command field and an IP address field. The search request filter 218 then associates with the field the particular value found in the request, for example the command may be GET and the IP address may be 123.45.5.67.

The search request filter 218 indexes the document in accordance with the API being used. As indicated herein, when a document is indexed for retrieval purposes in a searchable repository, keys are associated with fields within the document. The keys are then used during a search to retrieve documents having the searched values associated with the fields.

The search request filter 218 then may employ a Lucene API 222 to retain the information in a repository. Note, that in this exemplary embodiment, the Lucene API 222 is employed to create the repository of the requests and responses, discussed further herein. However, any indexing and searching interface could be used in implementation of an embodiment.

The documents indicative of the requests converted by the search request filter 218 are stored in the repository 221. As noted herein, the repository 221 may comprise a structured database of records representative of the request or a directory containing files indicative of the converted documents.

After the search, request filter 218 has completed storing the request in the repository 221, it signals the servlet container 214 that it has completed its task. The servlet container 214 then transmits the request to the servlet 220 for processing. The servlet 220 processes the request, formulates a response in accordance with the type of request received, then transmits the response to the servlet container 214.

The servlet container 214 then parses the response to determine what type of response is being transmitted. Much like the HTTP requests described herein, responses typically comprise predictable data, which may include commands, for example an OK indication or an error indication, or other data otherwise describing the response. Typically, this type of data is contained within a header, which makes up part of the response formulated by the servlet 220. As such, the servlet container is preferably configured to retain configuration data that associates a search filter with a particular piece of data. For example, the servlet container 114 may comprise configuration data indicating that all responses containing “OK” indications are sent to the search response filter 219. Therefore, when the servlet container 114 receives, from the servlet 220, a response that contains an OK indication, the servlet container 214 transmits the response to the search response filter 219.

In this regard, the servlet container 214 preferably compares selected pieces of parsed data with the configuration data to determine if a piece of data is associated with the search response filter 219. If the servlet container 214 determines that the data is associated with the search response filter 219, then the servlet container 214 transmits the request to the search response filter 219. Otherwise, the servlet container 214 transmits the response to the web server 213 for transmission to the client 102.

Upon receiving the request from the servlet container 214, the search response filter 219 may convert the data into a format that is compatible with the type of API that is being used, for example if using the Lucene API, then the search response filter 219 preferably converts the data into document having a plurality of fields. Further, associated with each field is a value. For example, the search request filter 218 may convert the request data into a document that has a status field, which indicates whether the processing of the request succeeded or failed. The filter 219 then associates with the field the particular value found in the request. For example, and OK command within the response may be associated with the status field.

The search response filter 219 indexes the document in accordance with the API being used. As indicated herein, when a document is indexed for retrieval purposes in a searchable repository, keys are associated with the fields within the document. The keys are then used during a search to retrieve documents having the searched values associated with the fields.

The search response filter 219 then may employ a Lucene API 222 to retain the information in a repository 221. Note that in this exemplary embodiment the Lucene API 222 is employed to create the repository 221 for the requests and responses. However, any type of servlet-based indexing and searching interface could be used in implementation of an embodiment of the invention.

The documents indicative of the responses converted by the search response filter 219 are stored in the repository 221. As noted herein, the repository 221 may comprise a structured database of records representative of the request or a directory containing files indicative of the converted documents.

As an example, the following exemplary request may be transmitted from the client 102 over network interface 210:

| | |
|---|---|
| GET /text/servlet/helloworld.htm HTTP/1.1 | A.1 |
| Host: 123.4.56.789 | B.1 |
| User-Agent: Mozilla/5.0 | C.1 |
| Accept: */* | D.1 |
| Accept-Encoding: gzip, deflate compress, identity | E.1 |
| Host: localhost:8080 | F.1 |
| Accept-Language: en | G.1 |
| Keep-Alive: 3000 | H.1 |
| Connection: keep-alive | I.1 |

The example request is in HTTP format, which is a standard format for a response, as described hereinabove. The HTTP example request is a simple HTTP request that indicates, to the servlet container 214, that the client 102 desires an HTML file entitled “helloworld.” Specifically, the first line A.1 is the actual request and the following lines are simply additional information used by the web server to establish the connection and communicate with the client 102. The lines provided are headers and, as such, are predictable, as described herein. Therefore, the search request filter 218 is preferably designed and configured in anticipation of the provided header in the HTTP response. The web server 213 receives the above-detailed request and transmits the request to the servlet container 214. The servlet container 214 compares the type of request, which is a GET type of request, with those that the servlet container 214 associates with the search request filter 218. If the servlet container 214 finds that a GET request is one that is associated with the search request filter 218, then it transmits the request to the search request filter 218.

The search request filter 218 then parses the request and retrieves, from the request, the information that the search request filter 218 uses in its indexing scheme for future search and retrieval. For example, the search request filter 218 may be configured to simply retrieve and index in the repository the actual request, (i.e. line A.1 in the instant example). However, the search request filter 218 may further be configured to retrieve and index the host identification number, B.1, or the language requested by the different clients, G.1.

After parsing the request to retrieve the data for indexing, the search request filter 218 uses the Lucene API 222 in order to index and/or search a repository created. Note that use of the Lucene API 222 is merely an example, and other software packages or APIs could be used in implementation of the of representative embodiments.

Once the search request filter 218 has completed its parsing and indexing of the request data, it then informs the servlet container 214 that it has completed its task. The servlet container 214 then relays the request to the servlet 220. The servlet 220 receives the request, processes the request, formulates a response, then transmits the response to the servlet container 214.

The following is an exemplary response generated by the servlet in response to the aforementioned request, and this response may be transmitted from the serviet 220 over network interface 210 to the client 102:

| | |
|---|---|
| HTTP/1.0 200 OK | A.2 |
| Server: WebStar 1.2 /ID CGI | B.2 |
| MIME-Version: 1.0 | C.2 |
| Content-type: text/htm | D.2 |

The example response is an HTTP response that transmits an HTML file to the client 102 with an indication of success, line A.2, which transmits “2000K.” Specifically, the first line A.1 is “2000K” header, which indicates that the response was successful. The HTTP response transmitted to the client comprises an html file, as indicated in line B.4. As described herein, the HTTP response includes a formatted header that includes defined data particular fields, therefore, the type of data included in the header is predictable. Therefore, the search response filter 219 is preferably designed and configured in anticipation of the provided header in the HTTP response. The servlet container 214 compares the type of response, which is an “200 OK” type of response, with those that the servlet container 214 associates with the search response filter 219. If the servlet container 214 finds that a “200 OK” response is one that is associated with the search response filter 219, then it transmits the response to the search response filter 219.

The search response filter 219 then parses the response and retrieves, from the response, the information that the search response filter 219 uses in its indexing scheme for future retrieval. For example, the search request filter 218 may be configured to retrieve and index in the repository the html file sent, which is indicated in line D.2.

After parsing the response to retrieve the data for indexing, the search response filter 219 uses the Lucene API 222 in order to index and/or search the repository 221 created. Note that use of the Lucene API 222 is merely an example, and other software packages or APIs could be used in other embodiments.

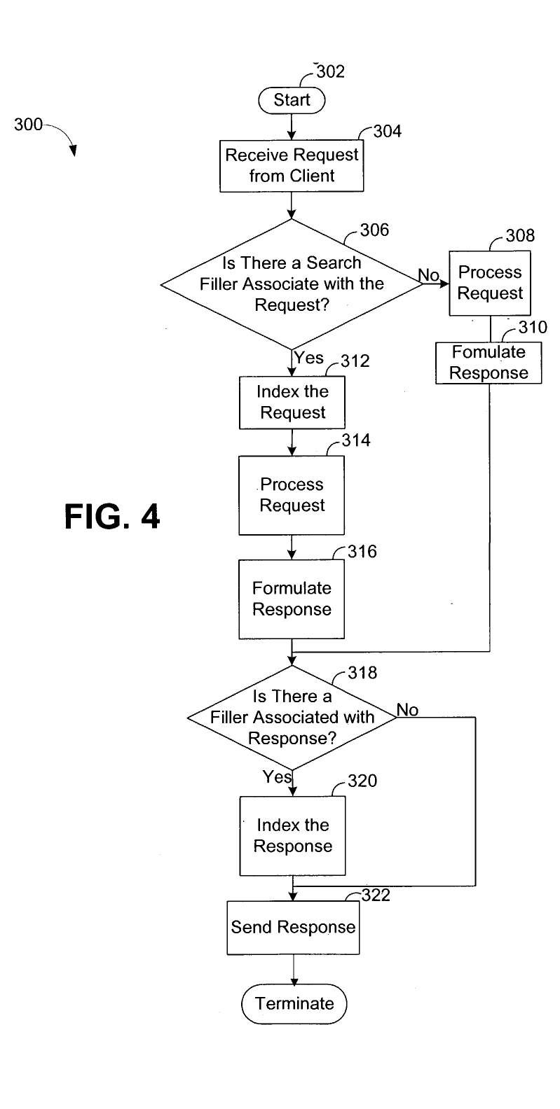

The architecture and functionality of an exemplary embodiment of a web server 200 is now discussed with reference to FIG. 4, and is designated generally throughout as method 300.

The web server 213 (FIG. 2) receives a request, for example an HTTP request, from a client 102 (FIG. 2), as indicated in step 304. The servlet container 214 determines whether there is a search filter associated with the request, as indicated in step 306. If there is no search filter associated with the type of request being made by the client, then the servlet 220 processes the request and formulates a response, as indicated in steps 308 and 310 respectively. The servlet container 214 then determines whether there is a search filter associated with the response formulated, as indicated in step 318. If there is not a filter associated with the response, then the servlet container 214 sends the response, as indicated in step 322. If there is a filter associated with the response, as indicated in step 318, the search response filter 219 indexes the response, as indicated in step 320, and the servlet container 214 then sends the response to the requesting client 102 (FIG. 2), as indicated in step 322.

If there is a search filter associated with the request in step 306, then the search request filter 218 indexes the request, as indicated in step 312. After the request is indexed, then the servlet 220 processes the request, as indicated in step 314 and formulates a response, as indicated in step 316.

The servlet container 214 then determines whether there is a search response filter associated with the response formulated by the servlet 220, as indicated in step 318. If there is a search filter associated with the type of response being transmitted by the servlet 220, the search response filter 219 indexes the response in step 320. After the response is indexed, the servlet container 220 transmits the response to the client 102, in step 322.

If there is not a search filter associated with the type of response being transmitted by the servlet 220 in step 318, then the servlet container sends the response to the requesting client 102, as indicated in step 322.

It should be emphasized that the above-described embodiments of the present invention, particularly, any “preferred” embodiments, are merely possible examples of implementations, merely set forth for a clear understanding of the principles of an embodiment of the invention. Many variations and modifications may be made to the above-described embodiment(s) of the invention without departing substantially from the spirit and principles of the embodiments of the invention. All such modifications and variations are intended to be included herein within the scope of this disclosure and the embodiments of the present invention and protected by the following claims.

Now, therefore, the following is claimed:

1. A server system for providing information regarding server traffic, comprising:
a servlet residing within a servlet container, the servlet configured to receive a request, process the request, and formulate a response corresponding to the request; and
logic contained within the servlet container, the logic configured to receive the request from the servlet container and configured to index data indicative of the request.

2. The server system of claim 1, wherein the data indicative of the request comprises a portion of the request.

3. The server system of claim 2, wherein the portion of the request is an HTML file name.

4. The server system of claim 1, further comprising logic within the servlet container configured to receive the formulated response and configured to index data indicative of the formulated response.

5. The server system of claim 4, wherein the data indicative of the response comprises a portion of the response.

6. The server system of claim 5, wherein the portion of the response is an HTML file.

7. The server system of claim 4, wherein the logic configured to receive and index the data indicative of the formulated response is implemented with a servlet-based application program interface (API).

8. The server system of claim 7, wherein the servlet-based application program interface is a Lucene API.

9. The server system of claim 4, wherein the logic configured to receive the request and the logic configured to receive the response are further configured to store the indexed data indicative of the request and the indexed data indicative of the response in a repository.

10. The server system of claim 9, wherein the repository is a servlet-based repository.

11. The server system of claim 9, wherein the servlet container is configured to receive the request and compare the request with a configuration file, the servlet container further configured to transmit the request to the logic configured to receive the request if the configuration file indicates that the request is associated with the logic configured to receive and index the data indicative of the request.

12. The system of claim 9, wherein the servlet container is configured to receive the response and compare the response with a configuration file, the servlet container further configured to transmit the response to the logic configured to receive and index the response if the configuration file indicates that the response is associated with the logic configured to receive and index the data indicative of the response.

13. The server system of claim 9, wherein the server system comprises a web server.

14. The server system of claim 13, wherein the servlet container is further configured to transmit the response to the web server if the configuration file does not indicate that the response is associated with the logic configured to receive and index the response.

15. The system of claim 14 further comprising a client, having a web browser, the web browser configured to receive a URL input, the client further configured to assemble the URL input into the request.

16. The system of claim 15, wherein the web browser is configured to store a search page, the search page comprising a text field for entering a text string, the client further configured to receive a text string and assemble the request for performing a search on the repository of requests and responses.

17. The system of claim 16, wherein the servlet is further configured to perform a search on the repository in response to a request from a client requesting a search, the servlet further configured to assemble a response comprising a set of matches to the search string and transmit the set of matches to the client.

18. A method for use within a web server, comprising the steps:
receiving a request within a servlet container of the web server, the request transmitted from a client to the web server;
indexing the request;
storing data indicative of the request in a repository;
formulating a response to the request; and
transmitting the response to the client.

19. The method of claim 18, wherein the repository is a servlet-based repository.

20. The method of claim 19, wherein the transmitting further comprises:
receiving the formulated response from a servlet;
indexing the response; and
storing the response in the repository.

21. The method of claim 20 wherein the receiving further comprises:
determining whether there is a search filter of the web server associated with a type of request indicated in the request.

22. The method of claim 20 wherein the receiving the formulated response further comprises:
determining whether there is a search filter of the web server associated with a type of response indicated in the response.

23. A web server for providing information regarding server traffic, comprising:
a servlet container residing within a web server, the web server configured to receive a request from a client and transmit the request to the servlet container;
a servlet residing within the servlet container, the servlet configured to formulate a response corresponding to the request, the servlet container configured to transmit the request to the servlet and receive the response from the servlet; and
a search request filter residing in the servlet container, the search request filter configured to receive the request from the servlet container, the search request filter further configured to index and store data indicative of the request in a repository;
a search response filter residing in the servlet container, the search response filter configured to receive the response from the servlet container, the search response filter further configured to index and store data indicative of the response in a repository.

24. The system of claim 23, wherein the servlet container is further configured to transmit the request and/or the response to the search filter if the servlet container determines that the request and/or the response is associated with the filter.

25. A server for providing information regarding server traffic, comprising:
means for receiving requests from at least one client;
means for receiving responses from a servlet;
search means for indexing and storing data indicative of the requests in a servlet-based repository; and
search means for indexing and storing data indicative of the responses in a servlet-based repository.

26. A computer program embodied in a computer readable medium for providing information regarding server traffic, the computer program comprising:
logic for to receiving a request within a servlet container of the web server, the request transmitted from a client to the web server;
logic for indexing data indicative of the request;
logic for storing data indicative of the request in a repository;
logic for formulating a response to the request;
logic for indexing data indicative of the response;
logic for storing data indicative of the response in a repository; and
logic for transmitting the response to the client.
